(19) United States
(12) Patent Application Publication
(10) Pub. No.: US 2025/0255764 A1
(43) Pub. Date: Aug. 14, 2025

(54) LOW NOISE INCUBATORS

(71) Applicant: MASIMO CORPORATION, IRVINE, CA (US)

(72) Inventors: BRENDON STEAD, Carlsbad, CA (US); DANIEL COREY WIGGINS, Henderson (CA)

(21) Appl. No.: 18/930,902

(22) Filed: Oct. 29, 2024

Related U.S. Application Data
(60) Provisional application No. 63/553,089, filed on Feb. 13, 2024.

(51) Int. Cl. A61G 11/00; G10K 11/175

(52) U.S. Cl. CPC A61G 11/009; G10K 11/175

(57) ABSTRACT

An incubator can include a body, a bed supported by the body, and a canopy defining an interior chamber that includes the bed. The incubator can include any combination of various features configured to reduce sound energy inside the incubator. The incubator can include a passive radiator, a Helmholtz resonator, a meta material absorber, an active noise cancelation system, a vented door latch assembly, an acoustically permeable seal, a pressure relief valve, a lift mechanism that uses a belt drive, double paned canopy walls, a bin with insulating compliant elements, a manual pressure release valve, a pressure differential notification system, non-parallel or curved canopy walls, a mattress with reticulated foam, and/or an acoustic filter.

### INCORPORATION BY REFERENCE TO ANY PRIORITY APPLICATIONS

This application claims the benefit of U.S. Provisional Application No. 63/553,089, filed Feb. 13, 2024, which is hereby incorporated by reference in its entirety. Any and all applications for which a foreign or domestic priority claim is identified in the Application Data Sheet as filed with the present application are hereby incorporated by reference under 37 CFR 1.57 for all purposes and for all that they contain.

### BACKGROUND

### Field of the Disclosure

Some embodiments disclosed herein relate to incubators, such as incubators with noise reduction features.

### Description of the Related Art

Brain development is correlated to quantity and quality of sleep, such as for infants, including premature infants. Disturbing the rest of a premature infant can slow cognitive development and can cause learning disabilities. Premature infants are often placed in an incubator, such as an isolette chamber, and some incubators can produce high noise environments that can disturb the rest of the infant. A need exists for incubators with low noise or with noise-reduction features.

### SUMMARY

Some embodiments disclosed herein can relate to an incubator, which can include a body, a bed supported by the body, a canopy defining an interior chamber that includes the bed, and at least one passive radiator.

Some embodiments disclosed herein can relate to an incubator, which can include a body, a bed supported by the body, a canopy defining an interior chamber that includes the bed, and at least one Helmholtz resonator.

Some embodiments disclosed herein can relate to an incubator, which can include a body, a bed supported by the body, a canopy defining an interior chamber that includes the bed, and at least one meta material absorber.

Some embodiments disclosed herein can relate to an incubator, which can include a body, a bed supported by the body, a canopy defining an interior chamber that includes the bed, and an active noise cancelation system. The active noise cancelation system can include a microphone positioned in the interior chamber of the incubator, and a processor configured to receive signals representative of noise recorded by the microphone. The processor can be configured to produce cancelation sound based at least in part on the signals received from the microphone. The active noise cancellation system can include a speaker configured to play the cancelation sounds.

Some embodiments disclosed herein can relate to an incubator, which can include a body, a bed supported by the body, a canopy defining an interior chamber that includes the bed, a door having a closed configuration and an open configuration that provides access to the interior chamber, and a latch assembly that includes one or more vent openings, and an actuator that is movable between a closed configuration that closes the one or more vent openings and an open configuration that opens the one or more vent openings so that air can flow between the interior chamber and an ambient area around the incubator. The latch assembly including a mechanism configured to interface with the actuator when the actuator moves beyond the open configuration so that movement of the actuator activates the latch assembly mechanism to release the door from the closed configuration. The vent openings can be open to permit air flow between the interior chamber and the ambient area before the door is released. The actuator can be a pull actuator. The actuator can be a push actuator. The actuator can be biased to the closed configuration.

Some embodiments disclosed herein can relate to an incubator, which can include a body, a bed supported by the body, a canopy defining an interior chamber that includes the bed, and a door having a closed configuration and an open configuration that provides access to the interior chamber. The door can have a vent handle that is configured to open a vent to permit air flow between the interior chamber and an ambient area outside the incubator before the door opens.

Some embodiments disclosed herein can relate to an incubator, which can include a body, a bed supported by the body, a canopy defining an interior chamber that includes the bed, and a door having a closed configuration and an open configuration that provides access to the interior chamber. The door can include one or more vent openings and a handle that is movable between a closed configuration that impedes air flow through the one or more vent opening and an open configuration that permits air flow through the one or more vent openings. A biasing member can be configured to bias the handle to the closed configuration. The force to move the handle to the open configuration can be less than the force to move the door to the open configuration, such that the handle is configured to open the vents to permit air flow between the interior chamber and the ambient area before the door opens.

Some embodiments disclosed herein can relate to an incubator, which can include a body, a bed supported by the body, a canopy defining an interior chamber that includes the bed, a door having a closed configuration and an open configuration that provides access to the interior chamber, and a seal configured to acoustically seal between the door and the canopy when the door is closed. The seal material can be configured to acoustically open when the door is open. The seal material can include a series of holes that acoustically close when the door is closed and that open as the door transitions from the closed position to the open position, so that air can flow through the seal.

Some embodiments disclosed herein can relate to an incubator, which can include a body, a bed supported by the body, a canopy defining an interior chamber that includes the bed, and one or more pressure relief valves.

Some embodiments disclosed herein can relate to an incubator, which can include a body, a bed supported by the body, a canopy defining an interior chamber that includes the bed, and a lift mechanism configured to raise or lower the bed and canopy. The lift mechanism can use a belt drive system.

Some embodiments disclosed herein can relate to an incubator, which can include a body, a bed supported by the body, and a canopy defining an interior chamber that includes the bed. The canopy can include at least one of polycarbonate, copolyester, and cellulosic.

Some embodiments disclosed herein can relate to an incubator, which can include a body, a bed supported by the body, and a canopy defining an interior chamber that includes the bed. One or more of the walls of the canopy can be double paned.

Some embodiments disclosed herein can relate to an incubator, which can include a body, a bed supported by the body, a canopy defining an interior chamber that includes the bed, a bin suspended from the body, one or more compliant elements disposed between the bin and the body to at least partially insulate the body from vibrations of the bin.

Some embodiments disclosed herein can relate to an incubator, which can include a body, a bed supported by the body, a canopy defining an interior chamber that includes the bed, and a manual pressure release valve. The incubator can include a first pressure sensor inside the incubator interior chamber, a second pressure sensor outside the interior chamber, and a processor configured to receive signal from the first pressure sensor and the second pressure sensor and to determine a pressure differential between inside the interior chamber and outside the interior chamber. The processor can be configured to provide a notification when a pressure differential is determined. The processor can be configured to provide a notification when a pressure differential above a threshold is determined.

Some embodiments disclosed herein can relate to an incubator, which can include a body, a bed supported by the body, and a canopy defining an interior chamber that includes the bed. The walls of the canopy can be non-parallel.

Some embodiments disclosed herein can relate to an incubator, which can include a body, a bed supported by the body, and a canopy defining an interior chamber that includes the bed. The walls of the canopy can be curved.

Some embodiments disclosed herein can relate to an incubator, which can include a body, and a bed supported by the body. Therein the bed can include a mattress that includes reticulated foam. The incubator can include a canopy that defines an interior chamber that includes the bed. The mattress can include a cover that is substantially acoustically transparent.

Some embodiments disclosed herein can relate to an incubator, which can include a body, a bed supported by the body, a canopy defining an interior chamber that includes the bed, and an acoustic filter.

### BRIEF DESCRIPTION OF THE DRAWINGS

Certain embodiments will be discussed with reference to the following figures, wherein like reference numerals can refer to similar features throughout. The figures are provided for illustrative purposes and the innovations are not limited to the specific implementations illustrated in the figures.

FIG. 1 shows a perspective view of an example incubator.

FIG. 2 shows a schematic diagram of the example incubator.

FIG. 3 shows an example embodiments of a passive radiator.

FIG. 4 shows an example embodiment of a Helmholtz resonator.

FIG. 5 shows an example embodiment of a meta material absorber.

FIG. 6 shows an example of a latch mechanism in a closed configuration.

FIG. 7 shows the example latch mechanism in an open configuration.

FIG. 8 shows another example of a latch mechanism in a closed configuration.

FIG. 9 shows an example of a latch mechanism in a closed configuration.

FIG. 10 shows an example embodiment of a vent handle in a closed state.

FIG. 11 shows the vent handle in an open state.

FIG. 12 shows an example of an acoustically leaky seal.

FIG. 13 shows an example of pressure relieve valves on the incubator.

FIG. 14A shows a single pane wall.

FIG. 14B shows a dual pane wall.

FIG. 14C shows acoustic waterfall plots for polycarbonate, copolyester, and cellulosic.

FIG. 15 shows a comparison of two shapes with the same area and different shapes.

FIG. 16A shows an example incubator with flat walls.

FIG. 16B shows an example incubator with curved walls.

FIG. 17 shows an example embodiment of a mattress for the incubator.

FIG. 18 shows an example embodiment of an incubator with a pushbutton pressure release valve.

FIG. 19 shows an example of a high-pass acoustic filter.

FIG. 20 shows an example of a band-stop acoustic filter.

FIG. 21A shows an example of a structure for coupling a bin to an example incubator.

FIG. 21B shows another example of a structure for coupling a bin to example incubator.

FIG. 22 shows a belt for use with an incubator lift system.

FIG. 23 shows an active noise cancelation system for an incubator.

FIG. 24A shows an example embodiment of a handle mechanism for an incubator in a closed configuration.

FIG. 24B shows the example handle mechanism for an incubator in an open configuration.

### DETAILED DESCRIPTION OF CERTAIN EMBODIMENTS

The various features and advantages of the systems, devices, and methods of the technology described herein will become more fully apparent from the following description of the examples illustrated in the figures. These examples are intended to illustrate the principles of this disclosure, and this disclosure should not be limited to merely the illustrated examples. The features of the illustrated examples can be modified, combined, removed, and/or substituted as will be apparent to those of ordinary skill in the art upon consideration of the principles disclosed herein.

Infants, especially premature infants, are often placed in an incubator, such as an isolette chamber, such as when in a Neonatal Intensive Care Unit (NICU). The incubator can provide a controlled environment for the infant, such as by controlling the temperature, oxygen content, air filtration, humidity, and/or light, etc. of the area inside the incubator. The incubator can be an isolette, which can isolate the infant from germs, for example. The incubator can include one or more sensors or other monitoring features for monitoring the patient. In some cases, the incubator can produce a relatively high-noise environment inside the incubator, which can disturb the rest of the patient. Poor sleep quality is correlated with impeded development in infants and can lead to delayed mental development and physical issues later in life, for example. Quality sleep can be beneficial to healing and development in various contexts. Although some embodiments are discussed in connection with incubators for use with infants, the principles and features disclosed herein can be applied to incubators, isolette, or other chambers for use with various other types of patients including children, adults, and elderly patients.

In some cases, the goal for sound levels inside a Neonatal Intensive Care Unit (NICU) can be about 40 to 45 dB sound pressure level (SPL), although higher noise levels can occur. An incubator can transmit ambient sounds and vibrations into the interior of the incubator, and in some cases, the incubator can actually amplify ambient noise so that the patient experience higher noise levels. Measurements of noise levels inside and outside some incubators showed that over a wide range of frequencies the incubators actually amplifies the sound, resulting in levels inside the incubator of up to about 18 dB higher than the sound outside the incubator. Accordingly, in some cases, rather than isolating the infant, the isolette tended to increase exposure to sound. The incubator (e.g., an isolette) can include one or more walls or partitions (e.g., on all four sides and a cover in some cases), such as to protect the infant. In some cases the partitions, walls, covers, and/or lids can be made of clear plastics (e.g., polycarbonate or acrylic). The infant can be placed inside the incubator, such as on a pad or cloth. Access to the infant (e.g., for performing medical care) can be achieved by opening the incubator, such as by opening one or more ports on the side(s), opening an entire side, or lifting a lid of the incubator. Measurements were taken showing that opening and/or closing of some incubators can produce noise spikes of over 100 dB SPL (e.g., 110 dB SPL). In some cases, use of the incubator can produce sounds that can disturb the patient. For example, raising and lowering the isolette chamber, accessing storage bins below the chamber, and/or rolling the isolette to new locations within the premises (e.g., NICU), can produce undesired noise levels (e.g., in excess of 85 dB SPL in some instances). Even if the sounds are transient, they can disrupt the rest of the patient in the incubator.

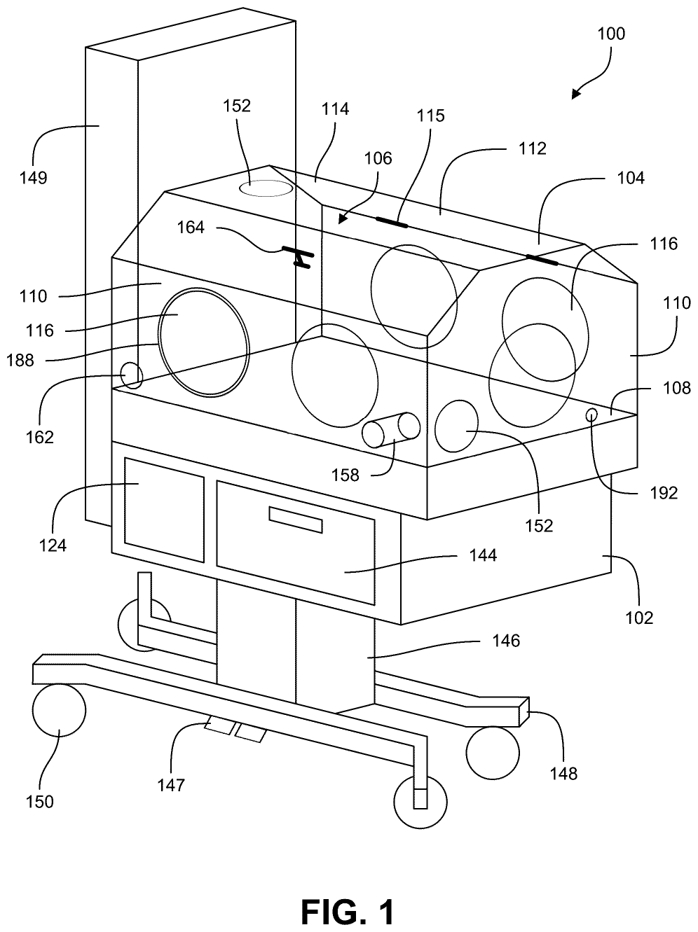

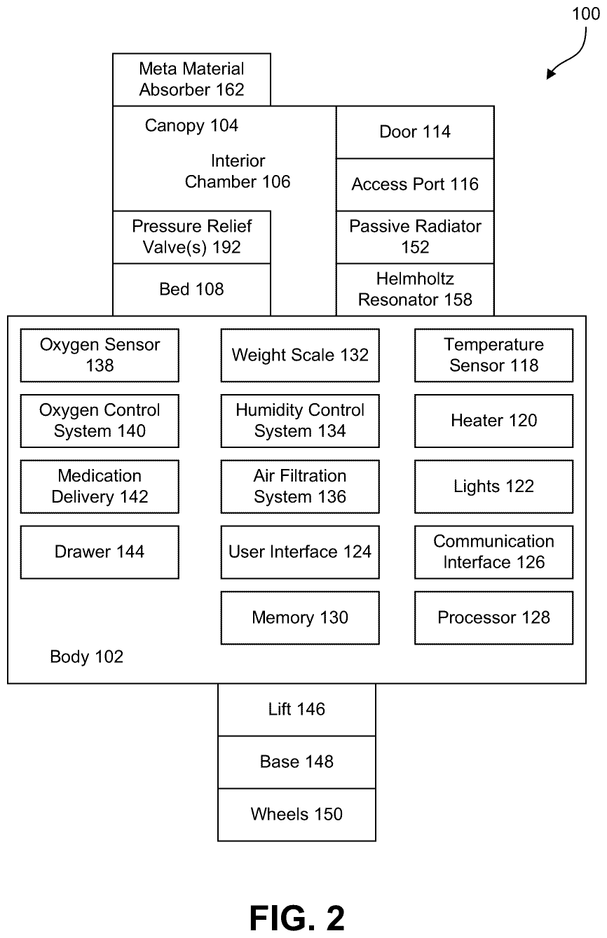

FIG. 1 shows an example embodiment of an incubator 100, which can include low-noise or reduced-noise features. FIG. 2 shows a schematic diagram of an example embodiments of the incubator 100. The incubator 100 can be configured to avoid or impede amplification of ambient sounds. In some embodiments, the incubator 100 can be configured to attenuate ambient sounds, for example so that the patient inside the incubator 100 experiences less noise than the ambient environment outside the incubator 100. The incubator 100 can include access features (e.g., one or more doors, covers, or ports) that can provide access to the patient inside the incubator 100 without producing loud sounds (e.g., below about 70 dB, about 65 dB, about 60 dB, about 55 dB, about 50 dB, about 45 dB, about 40 dB, about 35 dB, or about 30 dB SPL, or less, or any values or ranges between any of these values, although other configurations are possible). In some embodiments, the incubator 100 can be configured to be raised and/or lowered without producing loud sounds (e.g., below about 70 dB, about 65 dB, about 60 dB, about 55 dB, about 50 dB, about 45 dB, about 40 dB, about 35 dB, or about 30 dB SPL, or less, or any values or ranges between any of these values, although other configurations are possible). In some cases, the incubator 100 can include a storage compartment (e.g., a drawer), which can be opened and/or closed without producing loud sounds (e.g., below about 70 dB, about 65 dB, about 60 dB, about 55 dB, about 50 dB, about 45 dB, about 40 dB, about 35 dB, or about 30 dB SPL, or less, or any values or ranges between any of these values, although other configurations are possible). Additional features and aspects of the incubator 100 are discussed herein.

The incubator 100 can include a body portion 102 and canopy 104. The body portion 102 can support the canopy 104. The canopy 104 define an interior chamber 106. A bed 108 can be positioned inside the interior chamber 106. The bed 108 can include a cushion, a pad, a blanket, etc. The bed 108 can be configured to position the infant, or other patient, inside the interior chamber 106. The bed 108 and/or the body 102 can define a bottom of the interior chamber 106. The canopy 104 can include one or more side walls 110 (e.g., four walls), which can define the sides of the interior chamber 106, and a top wall 112 or cover, which can define the top of the interior chamber 106. The canopy 104 can include a door 114. For example, in some cases, the top 112, a side wall 110, or a portion thereof, can open to expose the interior chamber 106. In some cases, the canopy can include one or more access ports 116, which can enable a user to reach into the interior chamber without opening the full door 114. In some cases, the access port(s) 116 can be covered with door(s) that can be opened to provide access to the interior chamber 106 through the port(s) 116. In some cases, the port(s) 116 can include one or more glove ports or other membrane ports, which can enable a user to manipulate the interior chamber 106 while glove or other membrane separates the user from the interior chamber 106. Accordingly, the user can access the infant without exposing the infant to contact with the ambient area outside the incubator 100. In the embodiments illustrated in FIG. 1, the top of the canopy 104 can include hinges 115 so that the top 112 of the enclosure can lift as a door 114. The door 114 could be on a side panel 110 or any other suitable location. In some cases, multiple doors 114 can be used. The canopy 104 can have any suitable shape, such as a having 3, 4, 5, 6, 8 or more sides, having curved walls, having a single, bubble-shaped wall, etc.

The incubator 100 can include a temperature senor 118, which can measure the temperature of the interior chamber 106. Any suitable type of temperature sensor 118 can be used. The incubator 100 can include a heater 120, which can be used to heat the interior chamber 106, such as based on information from the temperature sensor 118 (e.g., with a feedback loop or any other suitable control technique). In some embodiments, a thermoelectric controller can be used. In some cases, the incubator 100 can have a temperature controller that can both heat and cool the incubator, which can facilitate control of the temperature. In some cases, the incubator can include one or more lights 122. The lights 122 can be used to heat the interior chamber 106 (e.g., using an infrared lamp or other suitable light). In some cases, the light(s) 122 can be used for phototherapy or for illumination.

The incubator 100 can include a controller that is configured to operate the incubator 100, such as to perform various functions and features described herein. The controller can include a processor 128, which can be a hardware processor, a computer processor, an integrated circuit, an application specific integrated circuit (ASIC), a general purpose processor, or the like. In some cases multiple processors 128 can be used, such as different processors for different functionality, or for load sharing or multi-threaded processing. The incubator 100 can include memory 130, which can store information. The memory 130 can be non-transitory computer-readable medium. The memory 130 can be non-volatile memory, or volatile memory, random access memory (RAM), or a hard drive, a solid state drive, flash memory, or any other suitable type of storage device. The memory 130 can include instructions, such as computer-readable instructions, which can be executed by the processor 128, such as to perform the functions and features discussed herein.

The incubator 100 can include a user interface 124, which can include one or more user input elements configured to receive input from a user, such as one or more buttons, keys, dials, switches, knobs, a keyboard, a mouse, a touch sensitive surface, etc. The user interface 124 can include one or more user output elements configured to output information to a user, such as a display (e.g., a touch screen display), a speaker, a printer, etc. The incubator can include a communication interface 126, which can send or receive information from an external device, such as over a network (e.g., a hospital network, the internet, etc.). The user interface can be wired or wireless, such as Ethernet, WiFi, Bluetooth, etc. The incubator 100 can receive input via the user interface 124 and/or the communication interface 126, and the incubator can perform operations based at least in part on the input. For example, the incubator can control the heater 120 to heat the interior chamber 106 based at least in part on a target temperature set by input, which can be received via the user interface 124 and/or from an external device via the communication interface 126. In some cases, the incubator 100 can output information (e.g., sensor data, patient information, incubator settings, alerts, error messages, etc.) via the user interface 124 and/or to an external device (e.g., a monitoring station) via the communication interface 126.

In some implementations, the incubator 100 can include a weight scale 132, which can be configured to measure the weight of the patient, of the bed 108, or of other components. The incubator 100 can include a humidity control system 134, which can include a humidity sensor and a humidity controller, which can access a water reservoir (or water source) and/or fan, or other features, to control the humidity in the interior chamber. The incubator 100 can include an air filtration system 136, which can include a fan to circulate air and one or more filters. Any suitable filters or filtering systems can be used. The incubator 100 can include an oxygen sensor 138, which can be configured to measure the oxygen level or content in the interior chamber 106. The incubator 100 can include an oxygen control system 140, which can access an oxygen reservoir or source and can control the oxygen in the interior chamber 106, such as at least in part based on the oxygen sensor 138. In some embodiments, the incubator 100 can include a medication delivery system 142, which can deliver medication to the patient. The incubator 100 can include one or more drawers 144, which can be opened and/or closed, such as to access one or more storage compartments. The incubator 100 can include a drawer or door that can be opened to provide access to a water reservoir, or an oxygen reservoir, or a medication reservoir, or any other portion or region of the incubator 100.

The incubator 100 can include a base 148, which can support the body 102. In some cases, the incubator 100 can include a lift 146 for adjusting the height of the body 102, the canopy 104, the interior chamber 106, the bed 108, and/or various other components. The incubator 100 can include lift controls 147, such as pedals or foot-operated switches, such as one to raise the incubator 100 and one to lower the incubator 100, however the user interface 124 could also be used. The incubator can include wheels 150 for moving the incubator 100, such as caster wheels. In some cases, the wheels can lock to impede movement of the incubator 100.

Some components that are shown in FIG. 2 as part of the body 102 of the incubator 100 can be partially or completely inside the interior chamber 106, such as the weight scale 132, the temperature sensor 118, the heater 120, the lights 122, the humidity sensor, the oxygen sensor 138, etc. Additional sensors or other components can be included with the incubator 100. In some embodiments, the incubator 100 (e.g., the body 102 thereof) can include a tower 149 or raised portion, which can include various components described or shown as part of the body 102, such as the user interface 124 (e.g., touch screen), the drug delivery system 142 (e.g., medication bag holder), lights 122, heater 120, etc. In some cases, some of the features of the incubator 100 can be omitted. For example, an some incubators 100 can omit the lift 146, the drawer 144, the lights 122, the medical delivery system 142, or various other components disclosed herein. The incubator 100 can include other features that are not shown or described as would be understood by a person of skill in this field.

In some embodiments, the incubator 100 can include one or more passive radiators 152. The passive radiator 152 can be placed on the top 112 of the enclosure or canopy 104 and/or on one or more of the sides 110 of the enclosure or canopy 104. In some embodiments, the door 114 can include one or more passive radiators 114. Any suitable number of passive radiators 152 can be used, such as 1, 2, 3, 4, 6, 8, 12, or more passive radiators 152. The passive radiator(s) 152 can be tuned to resonate 180 degrees out-of-phase with pressure waves inside the interior chamber 106 of the incubator 100. The passive radiator(s) 152 can be tuned to resonate out-of-phase (e.g., about 180 degrees out-of-phase) with specific frequencies or frequency ranges that are targeted for attenuation inside the incubator 100. For example, the opening and/or closing of the door 114 can produce sound of a frequency or frequency range. One or more passive radiators 152 can be configured to resonate out-of-phase (e.g., by about 180 degrees) with that frequency, or range of frequencies, or a frequency within the range. In some cases, peak frequency can be targeted, such as the frequency with the highest intensity. The passive radiator 152 can be configured to resonate out-of-phase (e.g., by about 180 degrees) with the frequency with the highest intensity during the event (e.g., opening and/or closing the door 114). Multiple passive radiators 152 could be used. The passive radiator(s) 152 can be tuned to different frequencies or ranges, such as by adjusting the mass of the moving portion and/or the stiffness of the suspension element.

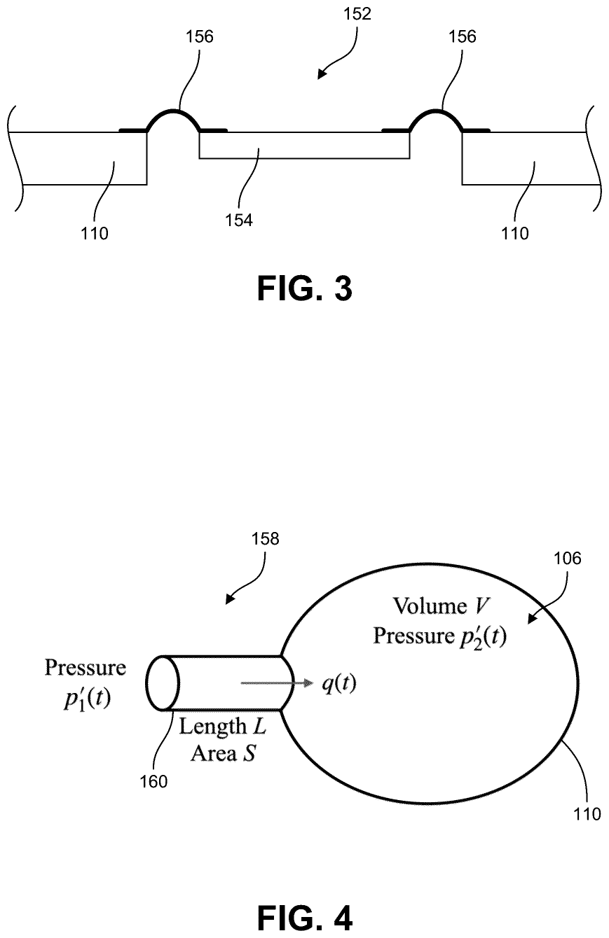

FIG. 3 shows an example embodiment of a passive radiator 152. The wall 100 of the enclosure or canopy 104 can have an opening. At least a portion of the diaphragm 154 or radiator mass can be positioned in the opening, or in front of the opening on one side or the other. A suspension 156 can couple the diaphragm 154 to the wall 110, and the suspension 156 can be configured to enable the diaphragm 152 to move (e.g., along a direction that is axial to the opening, which would be up and down in the orientation of FIG. 3). Movement of the diaphragm 154 can increase or decrease the volume of the interior chamber 106 depending on the direction of movement. That expansion or contraction can counter pressure waves in the incubator. Accordingly, the passive radiator(s) 152 can reduce the spikes of sound inside the interior chamber 106. The diaphragm 154 can be a cone, or a plate, or any suitable structure. The opening and/or diaphragm 154 can have a substantially circular shape in some cases, although any suitable shapes could be used. In some cases, the passive radiator 152 can be substantially optically clear, for example so as to not obstruct the view of the patient.

In some embodiments, the incubator 100 can include one or more Helmholtz resonators 158. The Helmholtz resonator(s) 158 can be placed on the top 112 of the enclosure or canopy 104 and/or on one or more of the sides 110 of the enclosure or canopy 104 and/or on the bottom of the chamber 108. In some embodiments, the door 114 can include one or more Helmholtz resonators 158. In some cases, the Helmholtz resonator 158 can be under or outside the enclosure and a pipe can direct the acoustical energy from the interior chamber 106 to the Helmholtz resonator 158. Any suitable number of Helmholtz resonators 158 can be used, such as 1, 2, 3, 4, 6, 8, 12, or more Helmholtz resonators 158. The Helmholtz resonator(s) 158 can be tuned to resonate 180 degrees out-of-phase with pressure waves inside the interior chamber 106 of the incubator 100. The Helmholtz resonator(s) 158 can be tuned to resonate out-of-phase (e.g., about 180 degrees out-of-phase) with specific frequencies or frequency ranges that are targeted for attenuation inside the incubator 100. For example, the opening and/or closing of the door 114 can produce sound of a frequency or frequency range. One or more Helmholtz resonator(s) 158 can be configured to resonate out-of-phase (e.g., by about 180 degrees) with that frequency, or range of frequencies, or a frequency within the range. In some cases, peak frequency can be targeted, such as the frequency with the highest intensity. The Helmholtz resonator(s) 158 can be configured to resonate out-of-phase (e.g., by about 180 degrees) with the frequency with the highest intensity during the event (e.g., opening and/or closing the door 114), by way of example. Multiple Helmholtz resonators 158 could be used. The Helmholtz resonator(s) 158 can be tuned to different frequencies or ranges, such as by adjusting the length, depth, cross sectional area and/or total volume of components of the Helmholtz resonator.

FIG. 4 shows an example embodiment of a Helmholtz resonator(s) 158. The wall 100 of the enclosure or canopy 104, or other portion of the incubator 100 can have an opening. A pipe 160 or tube can be coupled to the opening. The pipe 160 can be open at both ends, so that air can flow through the pipe 160. The opening and/or the pipe 160 can have substantially circular cross-sectional shapes in some cases, although any suitable shapes could be used. The pipe 160 can have a length L and an area S, which can be tuned to absorb or cancel energy of the target noise frequency or range. In some cases, multiple Helmholtz resonators 158 can be used, such as tuned to absorb different frequencies or ranges.

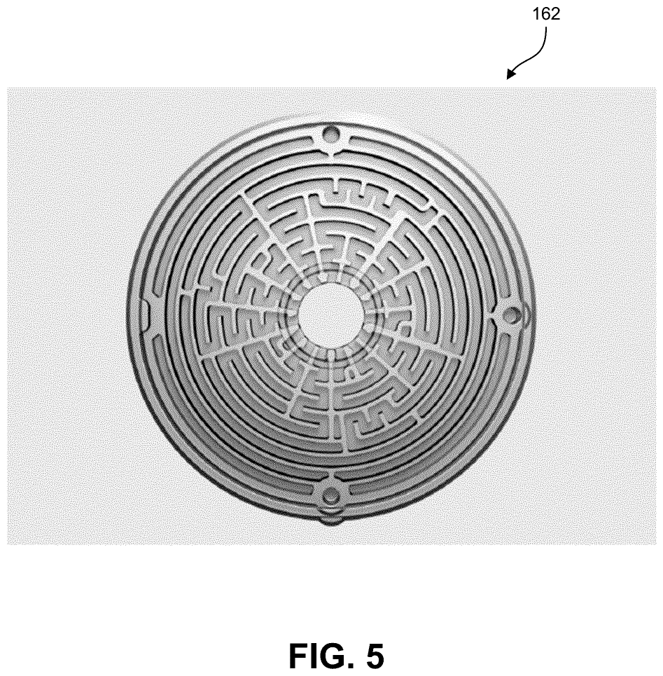

In some embodiments, the incubator 100 can include one or more meta material absorbers 162. Meta materials are a class of physical structures that have small features built into them that act as acoustical absorbers, such as over a wide range of frequencies. Sound can be trapped in the various paths of different sizes and shapes and can result in out-of-phase reflections The meta material absorber(s) 162 can be molded materials that can be mounted on the surfaces of the incubator 100 (e.g., on flat surfaces). The Meta material absorber(s) 162 can be mounted on an inside surface of the canopy 104, or other portion of the incubator 100. In some cases, the meta material absorber(s) 162 could be mounted on an outside of the canopy 104, or other portion of the incubator 100, such as to absorb ambient noise. The meta material absorber(s) 162 can be placed on the top 112 of the enclosure or canopy 104 and/or on one or more of the sides 110 of the enclosure or canopy 104. In some embodiments, the door 114 can include one or more meta material absorber(s) 162. Any suitable number of meta material absorber(s) 162 can be used, such as 1, 2, 3, 4, 6, 8, 12, or more. The meta material absorber(s) 162 can be tuned to absorb specific frequencies or frequency ranges that are targeted for attenuation inside the incubator 100. For example, the opening and/or closing of the door 114 can produce sound of a frequency or frequency range. One or more meta material absorber(s) 162 can be configured to absorb that frequency, or range of frequencies, or a frequency within the range. In some cases, a peak frequency can be targeted, such as the frequency with the highest intensity. The meta material absorber(s) 162 can be configured to absorb the frequency with the highest intensity during the event (e.g., opening and/or closing the door 114), by way of example. Multiple meta material absorbers 162 could be used. The meta material absorber(s) 162 can be tuned to different frequencies or ranges, such as by varying the cross sectional area and/or length of any given feature such that sound is reflected back out-of-phase, such as for a given frequency or range of frequencies. FIG. 5 shows an example embodiment of a meta material absorber 162.

In some embodiments, the incubator 100 can include a latch assembly 164 that breaks a seal or leaks before opening a door 114 or access port 116 (e.g., which can have doors). In some instances, much of the noise is due to opening and/or closing the door 114 or access ports 116 of the incubator 100. For some incubators, as the door starts to open, the movement of the door can cause the volume inside the incubator to change significantly, especially due to the relatively small volume of the interior chamber of the incubator, which can produce a significant pressure differential and resulting pressure wave. The incubator 100 can have a latch assembly 164 for opening a door 114 (e.g., of a main access opening or of an access port 116), where the latch assembly 164 is configured to open a vent path (e.g., an air pathway between the interior chamber 106 and the ambient area outside the incubator 100), such as before the door 114 is released or before the door 114 moves toward the open position. Then when the door 114 is released or starts moving, the pressure differential can be at least partially released through the open vent path, at least partially reducing the pressure wave. The latch 164 can “gradually” open a large, low restriction pathway for air to flow prior to opening the actual access port, which can result in a much lowered velocity of air into the incubator 100, thereby reducing noise.

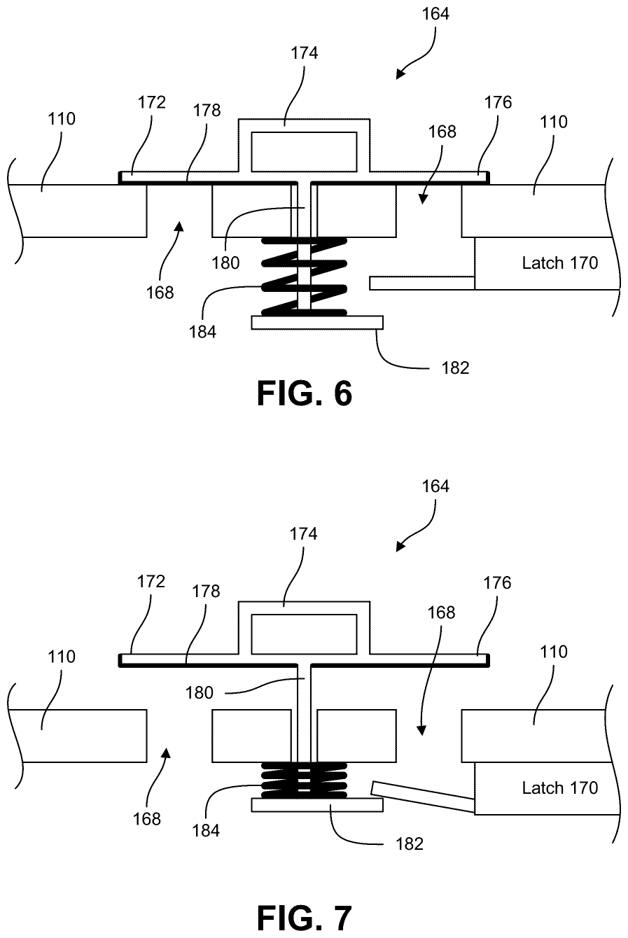

FIG. 6 shows an example latch assembly 164 in a closed configuration. FIG. 7 shows the example latch assembly 164 in an open configuration. The latch assembly 164 can include one or more openings 168 in the wall 110 or 112 of incubator 100. The latch assembly 164 can include an actuator 172, which can be manipulated by the user to trigger a latch 170 which can release or open the door 114. The actuator 172 can include a grip or handle 174 configured to be gripped or manipulated by the user to move the actuator 172. For example, the user can pull on the grip 174 to move the actuator 172, although a push actuator could be used in some implementations. The actuator 172 can include a cover 176, which can cover the one or more openings 168 when the actuator 172 is in a closed configuration. The cover 176 can include a seal 178, such as a flexible or elastomeric material (e.g., silicone or rubber), on the underside or on the side that faces the wall 110. The seal 178 can substantially seal against the wall 110 to close the one or more openings. When moved to the open configuration (e.g., in FIG. 7), the seal 178 can unseal from the wall 110 and air can pass through the one or more openings 168.

The actuator 172 can be biased to the closed configuration, such as by a spring 184, although any suitable biasing structure can be used (e.g., a resilient band, flexible arms, etc.). The actuator 172 can include a shaft 180 that extends from the cover 176, through an opening in the wall 110, and to a flange 182. The spring 184 can be positioned between the flange 182 and the wall 110. When the actuator 176 is moved to the open configuration (e.g., FIG. 7), the spring 184 can be compressed. When the force is released, the spring 184 can push the actuator 172 toward the closed position (e.g., FIG. 6).

The actuator 172 can trigger the latch 170, such as when it moves from the closed configuration to the open configuration. The latch 170 can have lever or other actuation member, which can extend into the path of the flange 182 as it moves from the closed configuration to the closed configuration. The flange 182 can include a protrusion or other structure configured to actuate the level, or other actuation member, of the latch 170, to thereby release the latch 170 and enable the door 114 to be opened.

Many variations are possible. In some cases, the seal 178 can be omitted. In some cases, the latch 170 can use a different mechanism to be triggered as the one or more openings. For example, the lever or latch mechanism can be coupled to the actuator 175, so that the lever moves as the user pulls, or pushes, the actuator 176, and the latch 170 can be configured to not release until after the actuator has moved sufficiently to open the one or more openings 168. In some cases, the lever or other latch mechanism can be tethered to the actuator 176 with some slack, so that the actuator 176 can move by a distance to open the one or more openings before the slack is removed. Then once the vent through the opening(s) 168 is open and the slack on the tether is removed, further movement of the actuator can cause the latch 170 to release or open the door 114.

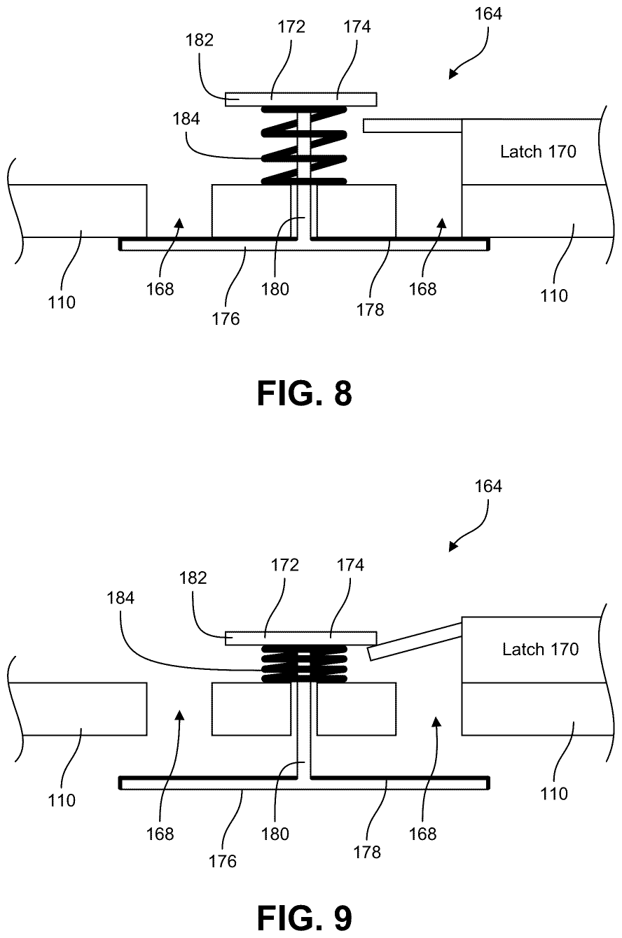

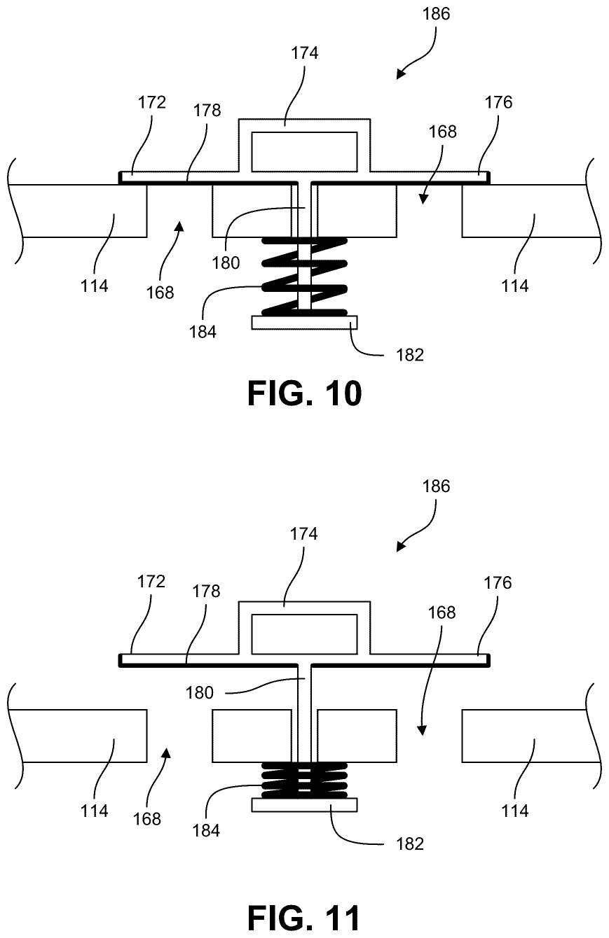

In some embodiments, the door 114 can include a vent mechanism integrated into the handle 174 for opening the incubator 100. FIG. 10 shows the vent handle 186 in a closed configuration. FIG. 11 shows the vent handle 186 in an open configuration. The vent handle 186 can include some features similar to the latch assembly 164 of FIGS. 6 to 9. However, the vent handle 186 can omit the latch 170. The user can pull on the handle 174 to open the door 114 of the incubator. The spring 184 and/or the door 114 can be configured so that the spring 184 at least partially compresses before the door 114 opens. For example, the force to compress the spring 184 can be less than the force to move the door 114. The spring 184 can be selected with a relatively low spring force, which can be sufficiently high to bias the actuator 172 to the closed configuration (e.g., FIG. 10), but can be sufficiently low that the spring compress to transition the actuator 172 to the open state (e.g., FIG. 11) before the door 114 opens. The door 114 (e.g., the hinges 115 thereof) can be configured to require a threshold amount of force before the door opens, and that threshold force can be higher than the amount of force to compress the spring 184 to open the vent handle (e.g., FIG. 11). When the user pulls the handle 174, the actuator 172 can move from the closed configuration of FIG. 10 to the open configuration of FIG. 11, for example without opening the door. In the open configuration the one or more openings 168 can be open to permit air to flow between interior chamber 106 of the incubator 100 and the ambient environment. By continuing to pull on the handle 174, such as with additional force, the user can open the door 114. Because the vent through the one or more openings 168 is open before the door moves significantly, the pressure differential caused by moving the door can be at least partially dissipated by venting air through the one or more openings 168. When closing the door, in some cases gravity can pull the door downward toward the closed position, which can compress the biasing member or spring 184 and open the openings 168 to vent air as the door is closed. Once the door is closed, the user can release the handle 174 or lower the handle 174 so that the cover 172 closes the openings 168. In some cases, the door 114 can be biased towards the closed position, such as by a spring, or other biasing member, or with one or more magnets. The force to move the cover 172 (e.g., and compress the spring or biasing member 184) can be less than the force to move the door 114. Thus the cover 172 can move to open the vents of openings 168 before the door 114 opens and/or the vent openings 168 can remain open until after the door 114 is closed. In some examples, the door 114 can be biased close by magnets so that pulling or pushing on the latch releases pressure by opening the vent but also provides a force to overcome the attraction of the magnets to open the door. The doors for the access ports 116 and/or one or more main access doors 114 can include the latch assembly 164 or the vent handle 186 embodiments.

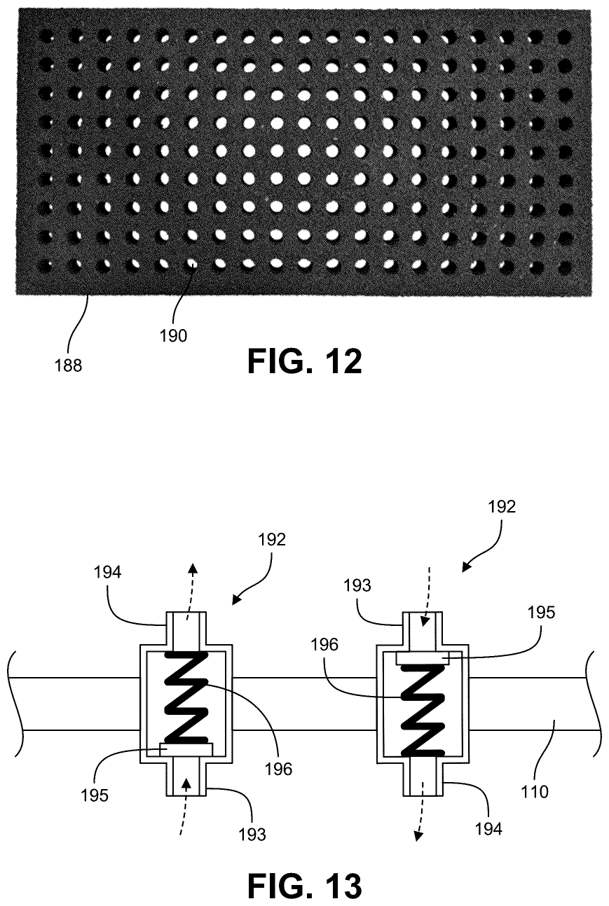

In some embodiments, the incubator 100 can have acoustically leaky seals 188, such as around the door 114 and/or around the access port(s) 116. In FIG. 1, one of the access ports 116 is shown surrounded by the seal 188. Although only one access port 116 is shown with the seal 188, for illustration, any number of openings, ports, doors, etc. can include the seal 188. FIG. 12 shows an example embodiment of the acoustically leaky seal material. The seal can include a soft compliant material with a series of holes 190 therethrough (e.g., arranged in a grid, although other arrangements of the holes could be used). When compressed, the seal material 188 can mostly or entirely close the holes 190. When the seal 188 is uncompressed, the holes 190 can open. The holes 190 can permit air to pass through the seal 188. The seal 188 can be sufficiently soft that the acoustic leak can be accelerated by a pressure differential. The doors for the access ports 116 and/or one or more main access doors 114 can include the acoustically leaky seal 188. In some embodiments, the seal 188 can have a relatively dense but porous material, such that air can flow through the seal 188, but only at a certain or restricted speed. As a pressure differential builds, the size of the pores can naturally increase so that the pressure releases. One example of the acoustically leaky seal 188 is reticulated foam with relatively small pore sizes.

The access port 116 can have an access door that can be opened or closed. When closed, the seal 188 can substantially seal the interface between the door and the access port 116. As the door for the access port 116 is opened, the seal 188 can expand to become acoustically leaky, such as to permit air to flow through the seal, such as to at least partially relieve a pressure differential produced by opening the door. When closing the door of the port 116, the seal 188 can permit air to flow through the seal as the door is closed, and can then seal acoustically when the door of the port 166 actually closes.

In some embodiments, the incubator 100 can include one or more pressure relief valves 192. The pressure relief valve(s) 192 can be placed on the top 112 of the enclosure or canopy 104 and/or on one or more of the sides 110 of the enclosure or canopy 104. In some embodiments, the door 114 can include one or more pressure relief valve(s) 192. Any suitable number of pressure relief valve(s) 192 can be used, such as 1, 2, 3, 4, 6, 8, 12, or more pressure relief valve(s) 192. FIG. 1 shows a single pressure relief valve 192 for illustration. The pressure relief valves can include check valves or one-way valves that are configured to permit air to flow in one direction through the valve, while substantially impeding flow of air in the other direction. The pressure relief valve(s) 192 can be tuned to open when a pressure differential between the internal chamber 106 of the incubator 100 and the ambient area outside the incubator is above a threshold amount. If a pressure differential above that threshold exists, the pressure relief valve 192 can open to permit air flow that reduces the pressure differential.

FIG. 13 shows an example embodiment that includes two pressure relief valves 192. A first press relief valve (e.g., on the left in FIG. 13) can permit fluid (e.g., air) to flow from the incubator to the ambient area outside the incubator. The second relief valve (e.g., on the right in FIG. 13) can permit fluid (e.g., air) to flow from the ambient area outside the incubator to the internal chamber 106 inside the incubator 100. The wall 100 of the enclosure or canopy 104 or door 114 can have an opening. The pressure relief valve 192 can include a housing with an inlet 193 and an outlet 194. Inside the housing the valve 192 can have a stopper 195, which can be biased to a closed position by a spring 196. The spring 196 can press the stopper 195 against the housing to close the inlet 193, for example. If a pressure differential is strong enough to compress the spring 106, the stopper 105 can retract from the housing to open the pressure relief valve 192. Air can pass through the pressure relief valve 192 when open. Once enough air has passed to reduce the pressure differential below the threshold the spring 196 can reseal the stopper 105 against the housing to close the valve 192. The pressure relief valve 192 on the left in FIG. 13 can open in response to a pressure differential where the internal incubator pressure is higher than an ambient pressure. The pressure relief valve 192 on the right in FIG. 13 can open in response to a pressure differential where the ambient pressure is higher the than internal incubator pressure. The incubator 100 can have two pressure relief valves 192 (e.g., as shown in FIG. 13), e.g., with opposite orientations, such as for bi-directional operation. Other types of pressure relief valves, check valves, or one-way valves can be used, such as a duck-bill check valve, etc.

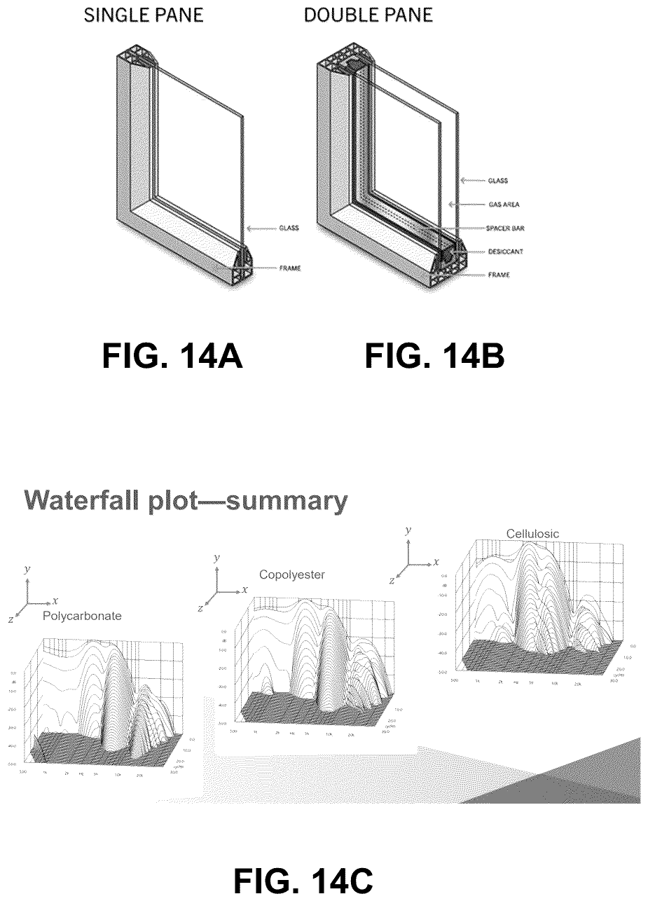

In some implementation, the incubator 100 can include dual wall construction, such as for the side walls 110, the top wall 112, the door 114, and/or for the covers of the access ports 116. FIG. 14. Any portion of the incubator 100 (e.g., isolette) cover can use dual wall or dual pane construction. FIG. 14A shows an example of single pane construction. FIG. 14B shows an example of dual pane construction. A first pane or sheet can be spaced apart from a second pane or sheet. The frame or housing can support the panes in the spaced-apart configuration. A gas or vacuum can be disposed between the panes. A spacer bar can be positioned between the panes, such as along the periphery or where the panes engage the frame or housing. The spacer bar can keep the panes spaced apart. A desiccant material can be used between the panes, in some cases. In some cases, the panes can be made of glass. In some embodiments, the panes can be made of plastic.

In some embodiments, the incubator can use plastics with relatively high internal loss to acoustic energy, which can increase the loss of noise transmitting through the plastics. For example, the plastic materials can reduce self-ringing and resonance of the plastic viewing parts of the incubator 100. For example, the side walls 110, the top wall 112, the door 114, and/or for the covers of the access ports 116 can be made of a plastic material, such as polycarbonate, copolyester, or cellulosic. In some cases, acrylonitrile butadiene styrene (ABS) plastic can be used. In some cases, Tritan copolyester can be used. FIG. 14C shows acoustic waterfall plots for polycarbonate, copolyester, or cellulosic. In some cases, these materials could be used for other components of the incubator 100, such as the body 102, the base 148, etc. In some cases, other materials could be used. In the waterfall plots, the X-axis (along the left-right direction on the bottom of the plots) is frequency in Hertz, the Y-axis (along the front-back direction on the right of the plots) is time in milliseconds, and the Z-axis (along the up-down direction on the left of the plots) is intensity in dB. In the plots, superior performance can be indicated by a lower amount of energy in time, thus minimizing the Y and Z axis components.

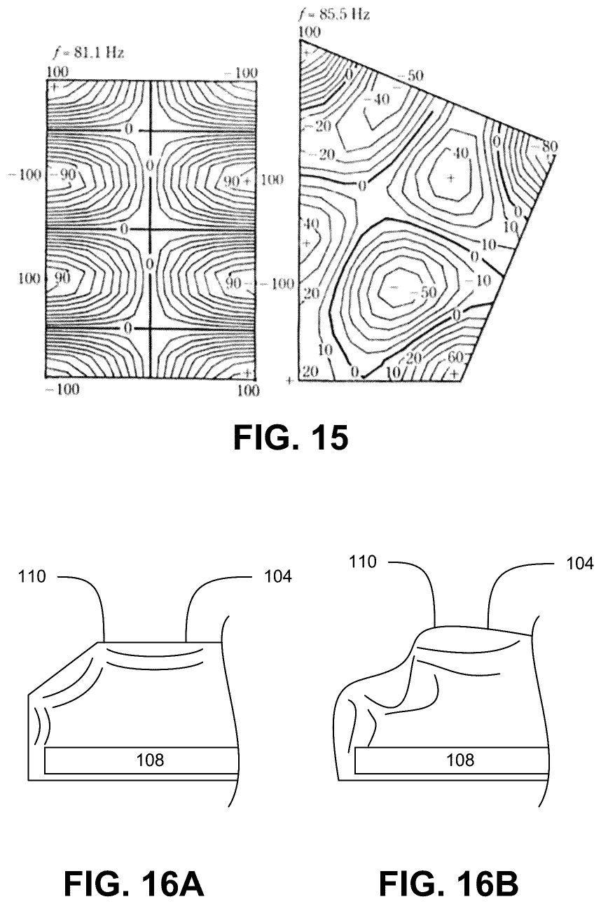

In some embodiments, the incubator 100 can be made of flat facets, such as with parallel sides. In FIG. 1, the incubator has a rectangular profile. In some cases, other shapes can be used, which can reduce or eliminate standing waves. By way of example, in some cases, the side walls 110 and/or the top wall 112 can be curved. In some cases, the side walls 110 can be arranged in a non-parallel configuration. FIG. 15 shows a comparison of two shapes with the same area. The shape on the left is rectangular, whereas the shape on the right is four-sided but nonrectangular, for example, the sides are non-parallel. FIG. 15 shows the 1,3 mode for the rectangular area and for the nonrectangular area. The sound field in the nonrectangular area is distorted as compared to the rectangular area. In some cases, the irregular shape does not necessarily reduce the overall energy internally, but it can distributes the energy in a manner that reduces the level over more areas.

In some embodiments, the incubator 100 can have an internal chamber 106 that does not have any corners or hard edges and/or flat surfaces. In some cases, the shape of the canopy 104 can direct energy away from the patient. The shape of the canopy 104 can dissipate energy away. In some cases, the curved surfaces are not parabolic in shape (e.g., which could focus the acoustic energy). The curved or angled surfaces can reduce or disrupt reflections, in some cases. FIG. 16A shows an example embodiment where the walls 110 of the incubator are flat, with corners. FIG. 16B shows an example embodiments where the walls are curved. The curved walls can disrupt reflections more than the flat walls.

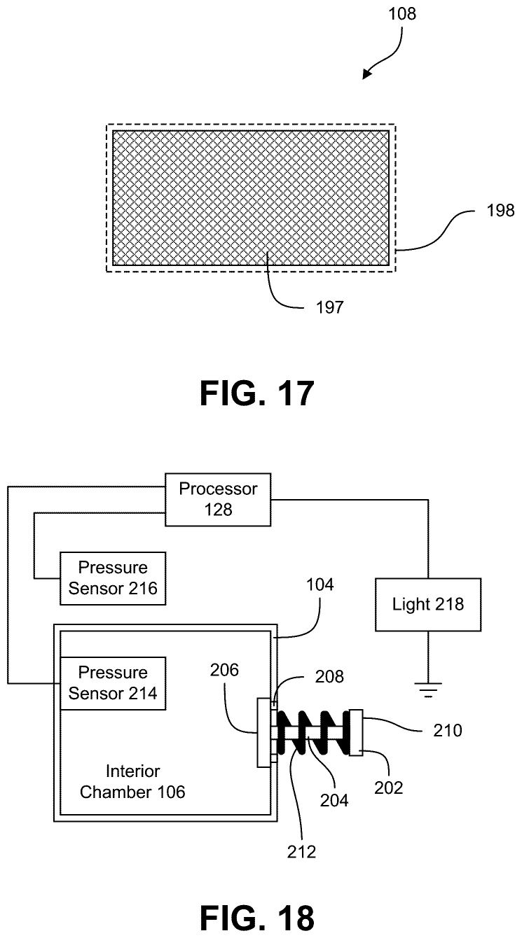

With reference to FIG. 17, in some embodiments, the incubator 100 can include a bed 108 with a mattress 197 that includes reticulated foam (e.g., highly reticulated foam). The mattress 197 can be placed inside a cover 198, which can be a fabric cover, which can be substantially acoustically transparent. In some cases, the cover can be hydrophobic. The cover 198 can permit sound to pass through to the mattress 197, and the mattress 197 can absorb sounds. In effect, the patient can sleep on a sound absorbing panel inside the incubator 100. Other types of beds can be used. In some cases, the bed 108 can include a mattress that includes polyurethane foam on the inside and a cover (e.g., a vinyl cover) on the outside.

In some embodiments, the incubator 100 can include a manual pressure release feature, such as a pushbutton pressure release valve 202. The pressure release valve 202 can include a shaft 204 that extends through an opening through the canopy 104 (e.g., through a wall 110). The end of the shaft 204 inside the interior chamber 106 can be coupled to a cover, which can cover and seal the shaft opening and/or one or more openings 208 through the canopy 204 (e.g., through the wall 110) when in the closed position, which is shown in FIG. 18. The side of the shaft 204 outside the internal chamber 106 can be coupled to a head 210. A spring 212 can be positioned between the head 210 and the wall 110, and the spring 212 can bias the pressure release valve to the closed position shown in FIG. 18. The user can press the head 210 to move the head 210, shaft 204, and cover 206 inward, so that the cover 206 unseals the one or more openings 308 through the canopy 204 (e.g., through the wall 110), so that air can flow between the interior chamber 106 and the ambient area outside the incubator 100, such as to equalize a pressure differential. The spring 212 can bias the valve 202 to the closed position.

In some embodiments, the incubator 100 can include a first pressure sensor 214 inside the interior chamber 106 and a second pressure sensor 216 outside the interior chamber 106. The processor 128 can analyze signals or data from the first pressure sensor 214 and the second pressure sensor 216, such as to determine a pressure differential between the interior chamber and the ambient environment. If the processor 128 determines that a pressure differential is present, or that a determined pressure differential is above a threshold pressure value (e.g., which can be stored in memory 130), the processor 128 can provide an alert or notification, such as via the user interface 124, the communication interface 126, and/or a light 218. For example the light 218 can illuminate when a pressure differential (e.g., above a threshold in some cases) is identified.

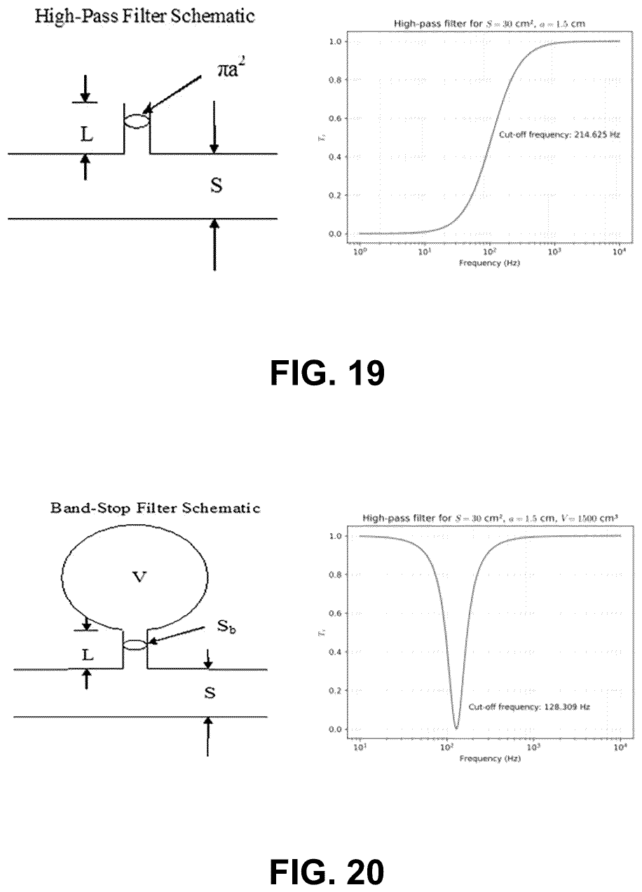

In some embodiments, the incubator 100 can include one or more acoustical filters. In some cases, the acoustical filter(s) can include an open pathway to the outside. Various types of filters can be used. For example, a high-pass filter can be used, as illustrated in FIG. 19. In some instances, a NICU has relatively low amounts of mid-to-high frequency noise content. Accordingly, a high pass filter can permit the higher frequencies to pass while attenuating the lower frequencies. The high-pass filter can be tuned to have a cut-off frequency according to the needs and goals of the particular circumstances. In some implementations, a band-stop filter can be used, as illustrated in FIG. 20. When a noise in a particular range of frequencies is the concern, a band-stop filter can attenuate that range of frequencies, while letting other frequencies pass through. The band of frequencies to be stopped can be tuned based on the particular circumstances. The filter can be built in mechanical structures, such as be hidden in floor or walls of the incubator 100. The filter(s) can include pathways with expansion chambers, side chambers, and openings that produce high pass, low pass, band stop, and/or band bass filter functions.

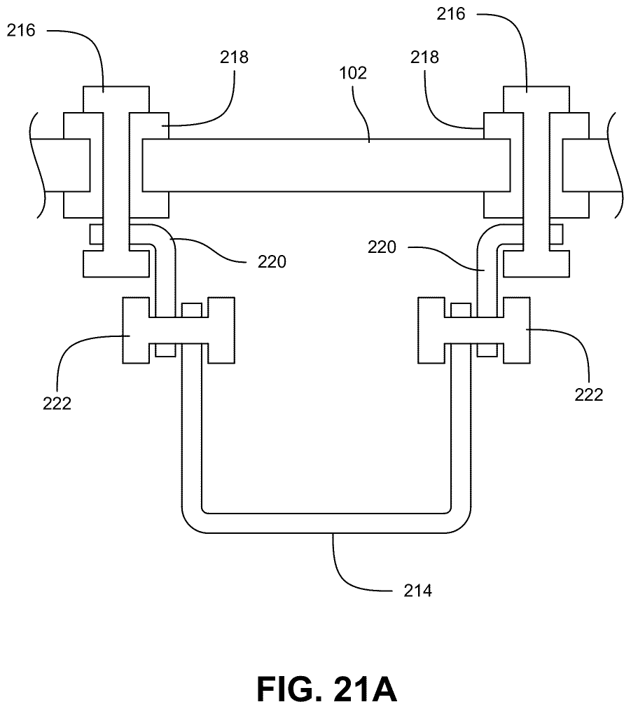

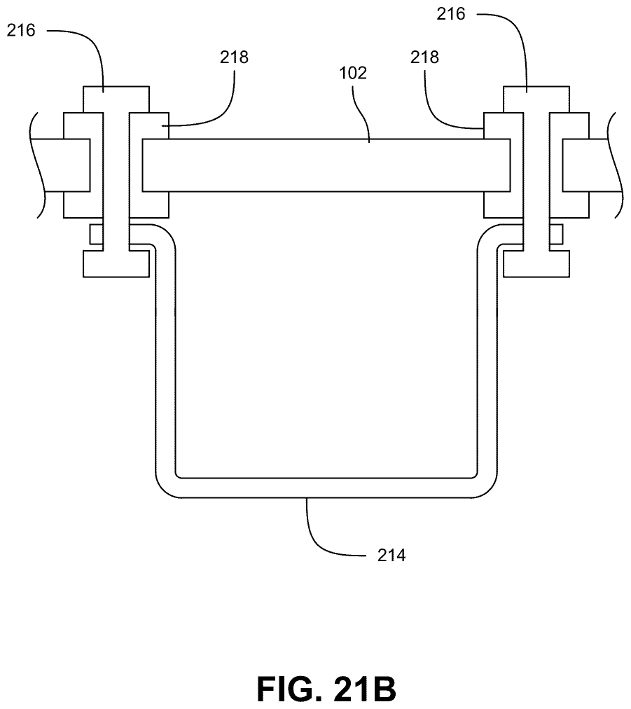

In some cases, the movement of storage compartments on the incubator can produce noise that can disturb the patient. For example, in some incubators, bins can be coupled to the frame or main body of the incubator with bolts or other hard couplings that can transfer vibrations from the bin to the frame of the incubator, and from there to the patient. For example, as a storage container slides (e.g., as a drawer or removable bin), that movement can produce vibrations and/or noise that can disrupt the patient. In some embodiments, the incubator 100 can include storage bins that are hung from lossy components to reduce or minimize transmission of noise and/or vibrations from the bin(s) to the body of the incubator 100. With reference to FIG. 21A, the bin can be suspended from the body 102 or frame of the incubator 100. The body 102 or frame can include two openings through which fasteners 216 can extend. Bushings 218 can be used between the fasteners 216 and the body 102. The bushings 218 can have a lower durometer than the fasteners 216. Polymer pieces 220 can be coupled to the fasteners 216 and can extend downward from the fasteners 216. Additional fasteners 222 can be coupled to the ends of the polymer pieces 220. A support 214 can be coupled to the additional fasteners 222. The support 214 can support a bin or a drawer or a storage container. In some cases, the support 214 can be a slide, along which a portion of the bin can slide as the bin moves (e.g., between a closed configuration and an open configuration). Various types of supports 214 can be used. In some cases, the bin can be removable and the support 214 can be a hook or other receiver for removably receiving the bin. The support 214 can be insulated from the frame or body 102 of the incubator by one or more compliant parts such that transmission of the drawer (e.g., which can slide in and out in the “U” of part the support 214 of FIG. 21A). Thus, vibration from the bin moving in and out can be attenuated or isolated from the main frame or body 102 of the incubator 100. One or more of the materials that couple the support 214 or the bin to the frame or body 102 (e.g., the bushing(s) 218, the fastener(s) 216, the coupling piece(s) 220, and/or the additional fasteners 222) can have a hardness of about 40, about 45, about 50, about 55, about 60, about 65, about 70 durometers, or more. FIG. 21B shows another example embodiment where the support 214 is coupled to the fasteners 216. The additional fasteners 222 and pieces 220 can be omitted, in some cases. In some cases, the pieces 220 can be absorbers configured to absorb vibrations. For example, in some implementations, the bushing(s) 218 and fasteners 216 can be tuned to reduce transmission of noise and/or vibration over a first range of frequencies, and the coupling piece(s) 220 and the additional fastener(s) 222 can be tuned to reduce transmission of noise and/or vibration over a second range of frequencies, which can be different from the first range of frequencies. The incubator can have one or more compliantly suspended bins. In some embodiments, double-compliance suspension can be used to couple the bin to the frame or body 102 of the incubator.

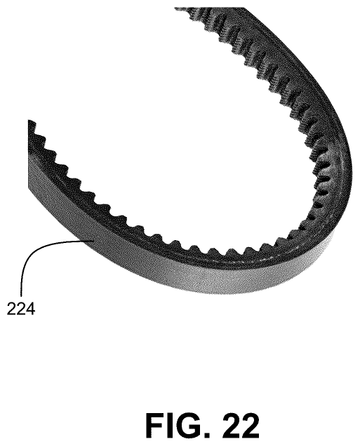

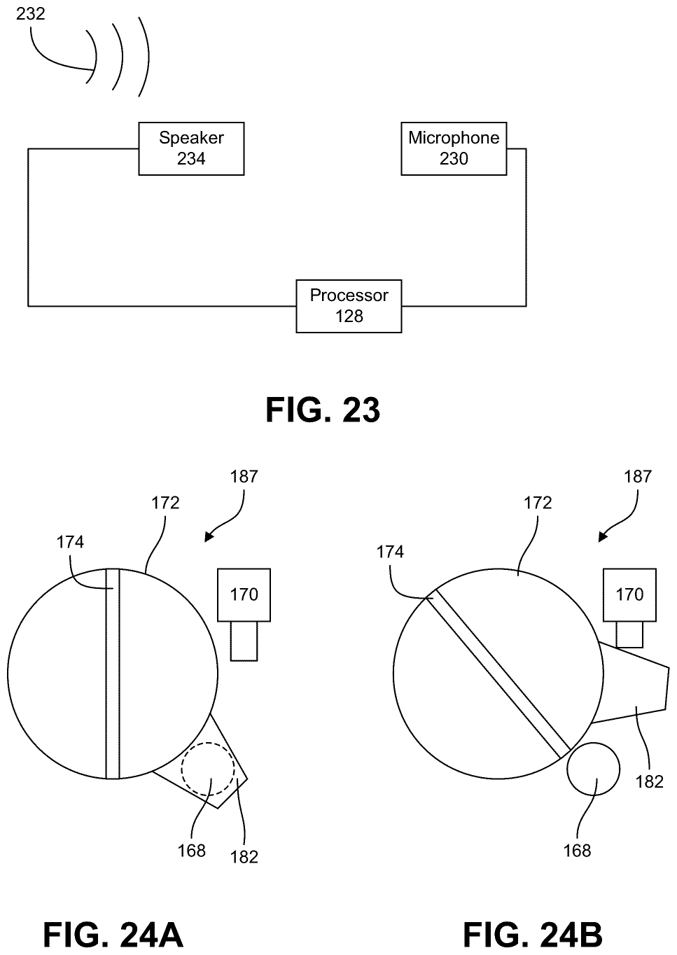

In some embodiments, the incubator can be raised and/or lowered using the lift 146. In some embodiments, the lift 146 does not use a chain driver or jack screws, since both of those can be mechanically noisy. Jack screws have several hard metal interfaces that generate noise and transmit vibration. The lift can use a pair of toothed wheels and a belt, which can be relatively quiet. FIG. 22 shows an example embodiment of a belt 224 that can be used with the lift 146. The belt 224 can have teeth on the inside, which can interface with teeth on a gear or wheel.

In some embodiments, the incubator 100 can use active noise cancellation. With reference to FIG. 22, the incubator 100 can include a microphone 230, which can be positioned hear the head of the patient when in the incubator 100. Noise 232 can be measured by the microphone 230, and corresponding signals can be sent to a processor 128, which can be a digital signal processor. The processor 128 can determine cancelation sounds based at least in part on the signals received from the microphone 230. For example, the cancelations sounds can be inverted versions of the sounds picked up by the microphone 230. The cancelation sounds can be played by a speaker 234. The cancelation sounds can attenuate the sounds 232, such as by destructive interference. In some cases, the active noise cancelling features can work best for canceling relatively low frequencies. The microphone 230 can be near the patient for a feedback approach. In some cases, the microphone 230 can be outside the incubator 100 or otherwise positioned so that the noise 232 reaches the microphone before reaching the patient, so that the system has time to prepare and play the cancelation sounds before the sound arrives at the patient. The noise cancelation system can use a feed forward approach, or a hybrid of feedback and feed-forward. In some cases, multiple microphones 230 can be used, such as at different locations (e.g., one near the patient inside the incubator 100 and one outside the incubator 100).

FIG. 24A shows an example embodiment of a rotating vented handle mechanism 187 in a closed configuration, and FIG. 24B shows the handle mechanism 187 in an open configuration. The handle mechanism 187 can include a handle or grip 174 that can be manipulated by a user, such as to rotate the handle mechanism. A cover 172 can rotate with the handle 174. The cover 172 can cover or close one or more openings 168 in a wall or door of the incubator when in the closed configuration. In FIG. 24A, the opening 168 is shown in a dashed line because it is covered. As the handle 174 is rotated, the cover 172 can move to an open position where the opening 168 is uncovered so that air can flow through the opening 168. The assembly can include a latch 170, which can be actuated to open a door 114. The handle mechanism 187 can include a protrusion or other actuation feature 182, which can trigger the latch 170 when the handle 174 is rotated further than the open position that opens the vent through the opening 168. Accordingly, when the door 114 is released to open, the vent can already be open so that a pressure differential from opening the door can be reduced.

### Additional Information

In some embodiments, the methods, techniques, microprocessors, and/or controllers described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination thereof. The instructions can reside in RAM memory, flash memory, ROM memory, EPROM memory, EEPROM memory, registers, hard disk, a removable disk, a CD-ROM, or any other form of a non-transitory computer-readable storage medium. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

The microprocessors or controllers described herein can be coordinated by operating system software, such as IOS, Android, Chrome OS, Windows XP, Windows Vista, Windows 7, Windows 8, Windows 10, Windows Server, Windows CE, Unix, Linux, SunOS, Solaris, iOS, Blackberry OS, VxWorks, or other compatible operating systems. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

The microprocessors and/or controllers described herein may implement the techniques described herein using customized hard-wired logic, one or more ASICs or FPGAS, firmware and/or program logic which causes microprocessors and/or controllers to be a special-purpose machine. According to one embodiment, parts of the techniques disclosed herein are performed a controller in response to executing one or more sequences instructions contained in a memory. Such instructions may be read into the memory from another storage medium, such as storage device. Execution of the sequences of instructions contained in the memory causes the processor or controller to perform the process steps described herein. In alternative embodiments, hard-wired circuitry may be used in place of or in combination with software instructions.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the techniques described herein may be implemented in analog circuitry or mixed analog and digital circuitry.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The words “coupled” or connected,” as generally used herein, refer to two or more elements that can be either directly connected, or connected by way of one or more intermediate elements. Additionally, the words “herein,” “above,” “below,” and words of similar import, when used in this application, shall refer to this application as a whole and not to any particular portions of this application. Where the context permits, words in the Detailed Description using the singular or plural number can also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a range of measurement error.

Although this disclosure contains certain embodiments and examples, it will be understood by those skilled in the art that the scope extends beyond the specifically disclosed embodiments to other alternative embodiments and/or uses and obvious modifications and equivalents thereof. In addition, while several variations of the embodiments have been shown and described in detail, other modifications will be readily apparent to those of skill in the art based upon this disclosure. It is also contemplated that various combinations or sub-combinations of the specific features and aspects of the embodiments may be made and still fall within the scope of this disclosure. It should be understood that various features and aspects of the disclosed embodiments can be combined with, or substituted for, one another in order to form varying modes of the embodiments. Any methods disclosed herein need not be performed in the order recited. Thus, it is intended that the scope should not be limited by the particular embodiments described above.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. Any headings used herein are for the convenience of the reader only and are not meant to limit the scope.

Further, while the devices, systems, and methods described herein may be susceptible to various modifications and alternative forms, specific examples thereof have been shown in the drawings and are herein described in detail. It should be understood, however, that the disclosure is not to be limited to the particular forms or methods disclosed, but, to the contrary, this disclosure covers all modifications, equivalents, and alternatives falling within the spirit and scope of the various implementations described. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including ambient temperature and pressure.

1. An incubator comprising:
a body;
a bed supported by the body;
a canopy defining an interior chamber that includes the bed; and
one or more of:
at least one passive radiator;
at least one Helmholtz resonator;
at least one meta material absorber;
an active noise cancelation system;
a door having a closed configuration and an open configuration that provides access to the interior chamber, wherein the door has a vent handle that is configured to open a vent to permit air flow between the interior chamber and an ambient area outside the incubator before the door opens;
a door having a closed configuration and an open configuration that provides access to the interior chamber, and a seal configured to acoustically seal between the door and the canopy when the door is closed, and wherein the seal material is configured to acoustically open when the door is open;
one or more pressure relief valves;
a manual pressure release valve;
a lift mechanism configured to raise or lower the bed and canopy, wherein the lift mechanism uses a belt drive system;
a bin suspended from the body, and one or more compliant elements disposed between the bin and the body to at least partially insulate the body from vibrations of the bin; and
an acoustic filter.

2. The incubator of claim 1 comprising:
the at least one Helmholtz resonator.

3. The incubator of claim 1 comprising:
the at least one meta material absorber.

4. The incubator of claim 1 comprising:
the active noise cancelation system.

5. The incubator of claim 4, wherein the active noise cancelation system includes:
a microphone positioned in the interior chamber of the incubator;
a processor configured to receive signals representative of noise recorded by the microphone, wherein the processor is configured to produce cancelation sound based at least in part on the signals received from the microphone; and
a speaker configured to play the cancelation sounds.

6. An incubator comprising:
a body;
a bed supported by the body;
a canopy defining an interior chamber that includes the bed;
a door having a closed configuration and an open configuration that provides access to the interior chamber; and
a latch assembly comprising:
one or more vent openings;
an actuator that is movable between a closed configuration that closes the one or more vent openings and an open configuration that opens the one or more vent openings so that air can flow between the interior chamber and an ambient area around the incubator; and
a mechanism configured to interface with the actuator when the actuator moves beyond the open configuration so that movement of the actuator activates the latch assembly mechanism to release the door from the closed configuration;
wherein the vent openings are open to permit air flow between the interior chamber and the ambient area before the door is released.

7. The incubator of claim 6, wherein the actuator is a pull actuator.

8. The incubator of claim 6, wherein the actuator is a push actuator.

9. The incubator of claim 6, wherein the actuator is biased to the closed configuration.

10. The incubator of claim 1 comprising:
the door having a closed configuration and an open configuration that provides access to the interior chamber, wherein the door has the vent handle that is configured to open the vent to permit air flow between the interior chamber and an ambient area outside the incubator before the door opens.

11. An incubator comprising:
a body;
a bed supported by the body;
a canopy defining an interior chamber that includes the bed; and
a door having a closed configuration and an open configuration that provides access to the interior chamber, wherein the door includes:
one or more vent openings;
a handle that is movable between a closed configuration that impedes air flow through the one or more vent opening and an open configuration that permits air flow through the one or more vent openings;
a biasing member configured to bias the handle to the closed configuration, wherein the force to move the handle to the open configuration is less than the force to move the door to the open configuration, such that the handle is configured to open the vents to permit air flow between the interior chamber and the ambient area before the door opens.

12. The incubator of claim 1 comprising:
the door having a closed configuration and an open configuration that provides access to the interior chamber; and
the seal configured to acoustically seal between the door and the canopy when the door is closed, and wherein the seal material is configured to acoustically open when the door is open.

13. The incubator of claim 12, wherein the seal material includes a series of holes that acoustically close when the door is closed and that open as the door transitions from the closed position to the open position, so that air can flow through the seal.

14. The incubator of claim 1 comprising:
the one or more pressure relief valves.

15. The incubator of claim 1 comprising:
the lift mechanism configured to raise or lower the bed and canopy, wherein the lift mechanism uses the belt drive system.

16. The incubator of claim 1 wherein the canopy includes at least one of polycarbonate, copolyester, and cellulosic.

17. The incubator of claim 1 wherein one or more of the walls of the canopy is double paned.

18. The incubator of claim 1 comprising:
the bin suspended from the body;
the one or more compliant elements disposed between the bin and the body to at least partially insulate the body from vibrations of the bin.

19. The incubator of claim 1 comprising:
the manual pressure release valve.

20. The incubator of claim 19, comprising:
a first pressure sensor inside the incubator interior chamber;
a second pressure sensor outside the interior chamber; and
a processor configured to receive signal from the first pressure sensor and the second pressure sensor and to determine a pressure differential between inside the interior chamber and outside the interior chamber.

21. The incubator of claim 20, wherein the processor is configured to provide a notification when a pressure differential is determined.

22. The incubator of claim 1 wherein the walls of the canopy are non-parallel.

23. The incubator of claim 1 wherein the walls of the canopy are curved.

24. The incubator of claim 1 wherein the bed includes a mattress that includes reticulated foam.

25. The incubator of claim 24, wherein the mattress includes a cover that is substantially acoustically transparent.

26. The incubator of claim 1 comprising:
acoustic filter.
